(19) United States
(12) Patent Application Publication
(10) Pub. No.: US 2006/0036852 A1
(43) Pub. Date: Feb. 16, 2006

(54) Byte-based data-processing device and the processing method thereof

(76) Inventor: Kwok-Yan Leung, Willowdale (CA)

Correspondence Address: SUPREME PATENT SERVICES, P.O. BOX 2339, SARATOGA, CA, 95070-0339, US

(21) Appl. No.: 10/918,924

(22) Filed: Aug. 16, 2004

(51) Int. Cl. H04L 9/00

(52) U.S. Cl. 713/160

(57) ABSTRACT

A byte-based data-processing method is provided to transmit data packets from a transmission end to a destination end swiftly and securely. The byte-based data-processing method is applied to compress a data packet to become a compressed data packet by means of a compression algorithm, then, encrypt the compressed data packet to become a compressed and encrypted data packet by means of an operation rule.

### BACKGROUND OF THE INVENTION

1. Field of the Invention

The present invention relates generally to a data-processing device and its processing method, and more specifically to a byte-based data-processing device and the processing method thereof.

2. The Prior Arts

Today's application of the Internet is no longer limited to static-state data access, and real-time data transmission, such as Internet video conference and Internet phone service become the mainstream application of the Internet. Almost all the known technologies applied for data transmission so far are built on the basis of UDP/IP (User Datagram Protocol/Internet Protocol) instead of the well-known static-state TCP-IP. The latter is not fitful with multicast and real-time data transmission, while the former provides a simplified and fast method for data transmission.

However, since UDP/IP only offers a least quality of service, it is possible to incur the problem of packet delay and/or packet loss during the real-time data-packet transmission. Therefore, the UDP/IP alone is not considered a preferred method for data-packet transmission.

For eliminating the defects mentioned above, a proposal that suggests to compress data before packet transmission and then decompress the data received is offered in the hope to have a data packet safely and stably transmitted through TCP/IP. Unfortunately, because principle of the data compression and decompression technology is quite simple, the compressed data packet might be intercepted by people intentioned en route of transmission, then decompressed and deciphered. Therefore, nor the proposal is a better way for data-delivery.

In order to highly maintain the secrecy of data, many kinds of encryption algorithms have been presented later on, such as the algorithm logic of: HMAC (Hash-based Message Authentication Code), GSM-A3, and GSM-A8. As those encryption rules can hardly be deciphered, the security of data-packet transmission can be heightened to a great extent indeed.

However, when both security and speed of data-packet transmission are expected, it may not work well enough by integrating the existing compression and encryption technology, in which encryption is achieved usually by adding some specific data to the head or tail of a data packet to inevitably enlarge the packet in volume and thereby make the compression effect meaningless.

### SUMMARY OF THE INVENTION

The primary object of the present invention is to provide a byte-based data-processing device and the processing method thereof for rapid and secure transmission of data packets.

In order to realize the mentioned object, an encryption/decryption module is applied for further encrypting/decrypting a compressed/decompressed data packet and transmitting the same rapidly and securely on byte basis.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a schematic view of a byte-based data-processing device of the present invention;

FIG. 2 is another schematic view of the byte-based data-processing device of the present invention;

FIG. 3 is a schematic view of a byte-based data processing method of the present invention;

FIG. 4 is a schematic view of a data packet of the present invention; and

FIGS. 5A and 5B represent schematic views of encryption algorithm of the present invention.

### DETAILED DESCRIPTION OF THE PREFERRED EMBODIMENT

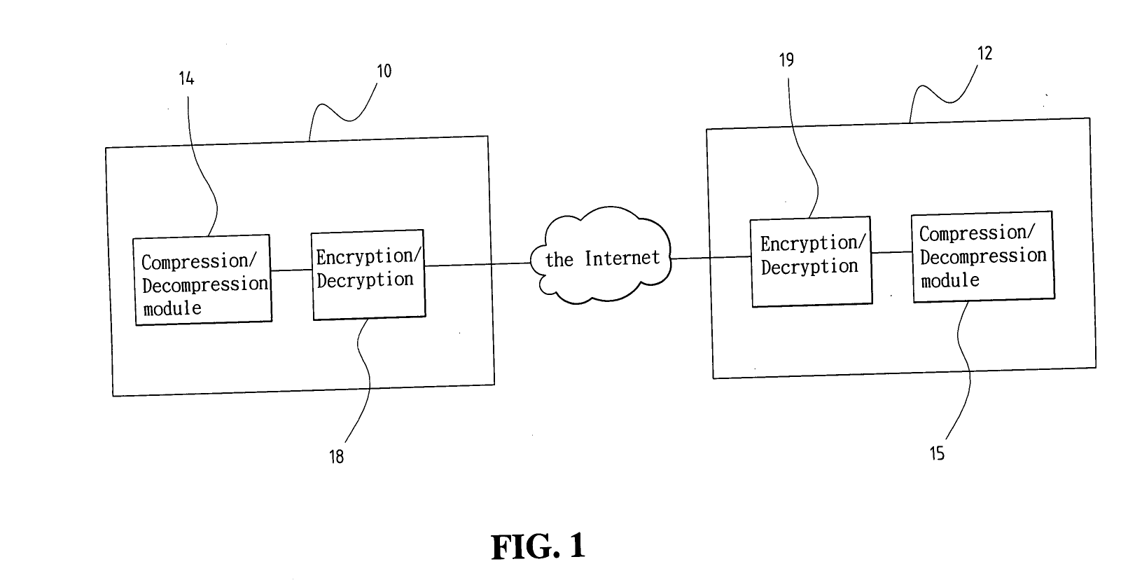

With reference to the drawings and in particular FIG. 1, a byte-based data-processing device in accordance with the present invention comprises a transmission end 10 and a destination end 12, which are provided with a compression/decompression module 14, 15 and an encryption/decryption module 18, 19 respectively. A data packet of the transmitting end 10 is supposed to undergo the compression/decompression module 14 and the encryption/decryption module 18 for being compressed and encrypted before outputting, such that it can be transmitted through the Internet in accordance with TCP/IP to reach the destination end 12 swiftly and securely. After receipt of the processed data packet from the transmission end 10, the data packet is requested to undergo the compression/decompression module 15 and the encryption/decryption module 19 to perform a reverse operation for reading the content of the data packet at the destination end 12.

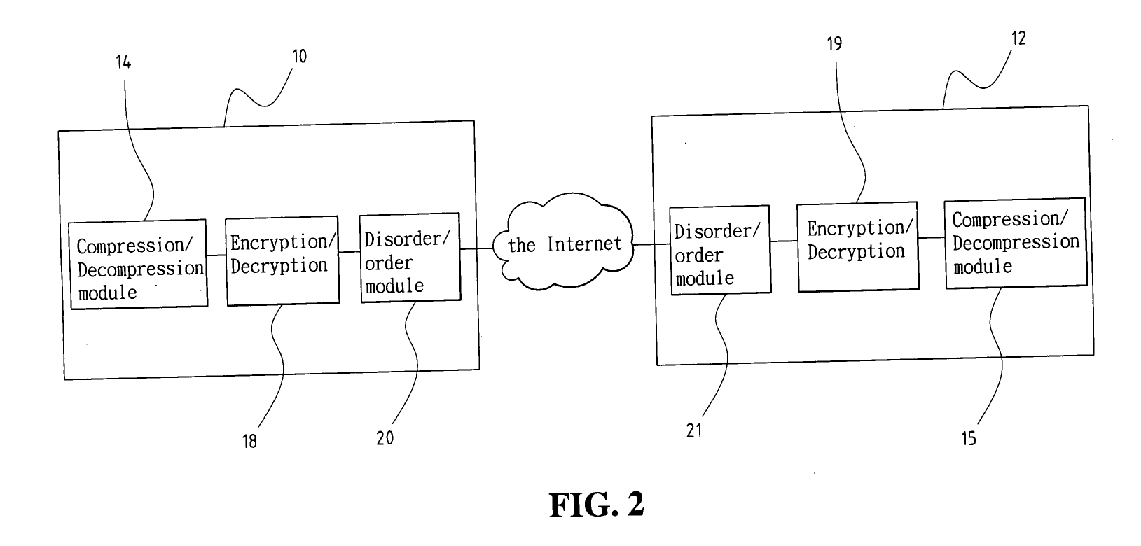

Also referring to FIG. 2, the byte-based data-processing device of the present invention is further provided with a disorder/order module 20, 21 at the transmission end 10 and the destination end 12, respectively. The disorder/order module is applied to disorder/order the alignment of a plurality of compressed and encrypted bytes according to the rules of disorder. In other words, a compressed and encrypted data packet created at the encryption/decryption module 18 at the transmission end 10 would undergo the disorder/order module 20 for maintaining secrecy further by disordering the bytes aligned in order. When a data packet reaches the destination end 12, the bytes disordered at the transmission end 10 are reordered here at the destination end 12.

The operation will be described below in detail.

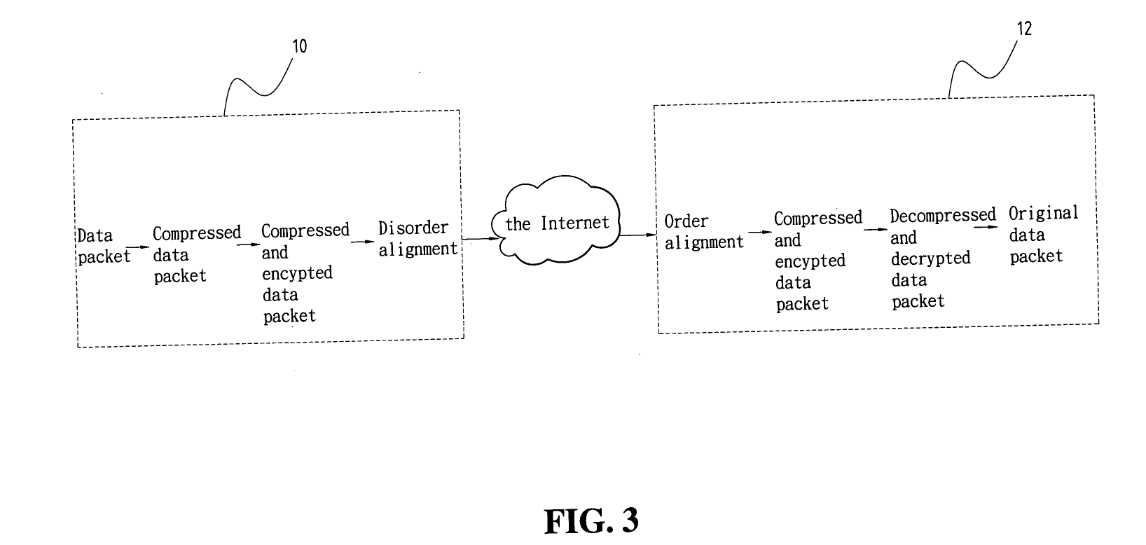

Referring to FIG. 3, on the transmission side, the byte-based data processing method is performed to compress a data packet by means of the compression/decompression module 14 by byte according to the compression algorithm, then, encrypt the compressed data packet by means of the encryption/decryption module 18, and finally, disorder the alignment of the data packet by means of the disorder/order module 20. When the data packet transmitted from the transmission end 10 is received at the destination end 12 through the Internet, it will be reordered by means of the disorder/order module 21, then, decrypted by means of the encryption/decryption module 19, and decompressed by means of the compression/decompression module 15 to recover it back to its original appearance for reading.

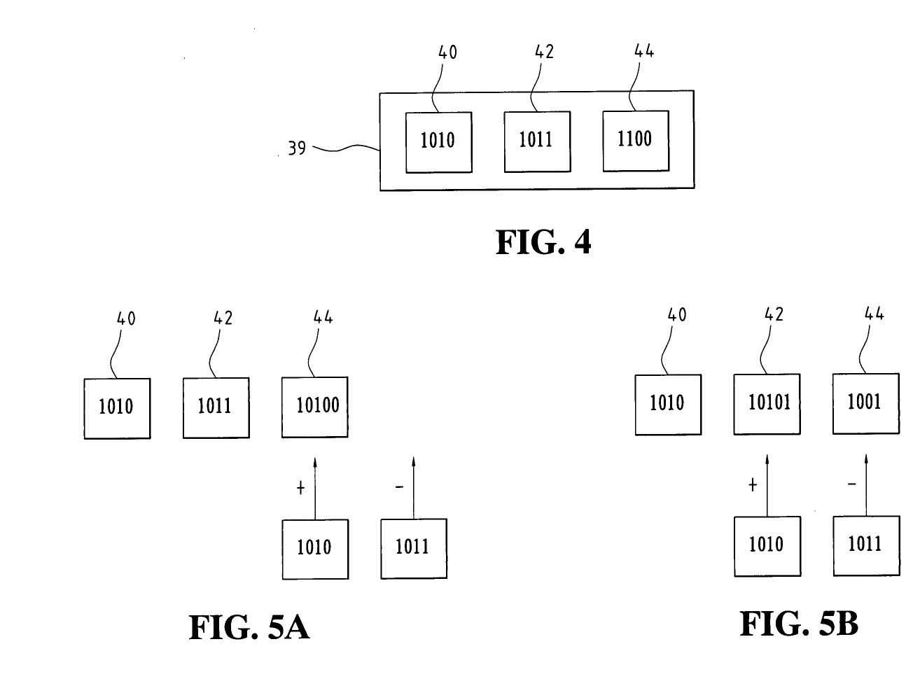

FIG. 4 is a schematic view of a data packet of the present invention. As shown in FIG. 4, there is a data packet 39, containing byte 40, 42, 44 in respective binary codes (1010), (1011), and (1100), for example.

FIGS. 5A and 5B represent schematic views of encryption algorithm of the present invention. To encrypt a compressed data packet by means of the encryption/decryption module 18 shown in FIG. 1 according to the basic operation rules including only addition, subtraction, multiplication, and division could be explained by FIG. 5A. Suppose every byte entering the transmission end 10 is compressed already, it will be then encrypted in the encryption/decryption module 18 using two specific numerals (1010) and (1011), namely, it is supposed to be added by (1010), and then subtracted by (1011). This procedure will be reversed in the encryption/decryption module 19 at the destination end 12. Namely, every byte received at the destination end 12 will be decrypted at the encryption/decryption module 19 by decreasing (1011) first, then adding (1010).

Taking the byte 44 for instance, (1010) is added to its original value (1100) to become (10100) shown in FIG. 5A according to the binary-code operation rules. Then, (1011) is subtracted from (10100) to result in (1001). While in the case of byte 42, (1010) is added to its original value (1011) to become (10101).

In short, the byte-based data-processing method of the present invention is designed to use the known compression/decompression techniques applied in the compression/decompression module 14, 15 for compressing and decompressing a data packet, and use the encryption/decryption techniques provided by the present invention to encrypt and decrypt the data packet to enhance the data packet's secrecy merely by using the usual operation rules (including square or cube root, and triangular function) without enlarging volume of that data packet.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A byte-based data-processing method for transmitting a data packet from a transmission end to a destination end swiftly and securely, comprising the followings steps:
(a) compressing the data packet into a compressed data packet according to a byte-based compression algorithm; and
(b) encrypting the compressed data packet into a compressed and encrypted data packet in accordance with an operation rule.

2. The data-processing method as claimed in claim 1 further comprising a step of disordering the alignments of a plurality of bytes contained in the compressed and encrypted data packet based on a disorder rule for arrangement.

3. The data-processing method as claimed in claim 1, wherein the operation rule comprises a basic operation containing addition, subtraction, multiplication, and division, and wherein a compressed data packet is further encrypted based on a predetermined numeral in accordance with the basic operation to become a compressed and encrypted data packet.

4. A byte-based data-processing method for transmitting a data packet from a transmission end to a destination end swiftly and securely, comprising the following steps:
(a) decrypting a compressed and encrypted data packet according to a byte-based operation rule to become a compressed and decrypted data packet; and
(b) decompressing the compressed and decrypted data packet according to a byte-based compression rule to become the original data packet.

5. The data-processing method as claimed in claim 4, further comprising a step of ordering the alignment of the bytes contained in the compressed and encrypted data packet, which has been disordered based on a disorder alignment rule.

6. The data-processing method as claimed in claim 4, wherein the operation rule comprises a basic operation containing addition, subtraction, multiplication, and division, and decrypting the compressed and encrypted data packet based on a predetermined numeral and the basic operation rule to become a compressed and decrypted data packet.

7. A byte-based data-processing device for transmitting a data packet from a transmission end to a destination end swiftly and securely, comprising:
a byte-based compression/decompression module for compressing/decompressing a data packet to become a compressed/decompressed data packet by means of a compression algorithm; and
a byte-based encryption/decryption module for encrypting/decrypting a compressed/decompressed data packet according to an operation rule to become a compressed and encrypted/decompressed and decrypted data packet.

8. The byte-based data-processing device as claimed in claim 7 further comprising a disorder/order module for disordering/ordering the bytes contained in a compressed/encrypted data packet according to a disorder alignment rule.
